(19) United States
(12) Patent Application Publication
(10) Pub. No.: US 2025/0138869 A1
(43) Pub. Date: May 1, 2025

(54) SYSTEMS AND METHODS FOR PROVIDING MODEL-GENERATED CONTENT BASED ON PRIVATE DATA

(71) Applicant: JPMORGAN CHASE BANK, N.A., New York, NY (US)

(72) Inventors: Jacky CT CHAN, Hong Kong (HK); Sebin THOMAS, London (GB); Terry TANG, Basingstoke (GB); Michael T. LEUNG, Sutton (GB); Fei CHEN, Plano, TX (US); Sean MORAN, London (GB); Amal VAIDYA, London (GB); Senad IBRAIMOSKI, London (GB); Mohan Krishna VANKAYALAPATI, Bournemouth (GB)

(21) Appl. No.: 18/907,124

(22) Filed: Oct. 4, 2024

Related U.S. Application Data
(60) Provisional application No. 63/588,192, filed on Oct. 5, 2023.

(51) Int. Cl. G06F 9/48; G06F 9/54

(52) U.S. Cl. CPC G06F 9/4856; G06F 9/54

(57) ABSTRACT

In some embodiments, the techniques described herein relate to a method including: receiving, at a query management platform and from a client device, a query, wherein the query includes an application identifier of an application to be migrated from the client device to a cloud based platform; retrieving, by the query management platform and from a context data store, context data; generating, by the query management platform, a prompt including the query and a migration profile including the context data as an embedding and provide the prompt to the machine learning model; receiving a request to search a vector database for a stored term similar to a query term and providing the stored term and a vector to the machine learning model; receiving an executable script in response to the migration profile; and executing the executable script to migrate the application from the client device to the cloud based platform.

### RELATED APPLICATIONS

Embodiments This application claims the benefit of U.S. Provisional Patent Application Ser. No. 63/588,192, filed Oct. 5, 2023. The disclosure of which is hereby incorporated, by reference, in its entirety.

### BACKGROUND

### 1. Field of The Invention

Embodiments generally relate to systems and methods for providing model-generated content based on private data.

### 2. Description of the Related Art

Technology engineers must determine large amounts of information with respect to an application when planning application maintenance or troubleshooting, such as application migrations to different environments or code refactoring. Recently, machine learning models such as large language models have proven effective in determining responses to queries where the model has access to relevant information with respect to the query. Generally, however, an organization's information with respect to its technology infrastructure, applications, applications' deployments, and applications' dependencies, are not public and/or are not formatted correctly. Therefore, the organization's information is unavailable for a machine learning model to access, search, analyze and generate responses from. There is a need to take full advantage of advances in machine learning models when migrating applications to a cloud platform. There is also a need for a machine learning engine to be able to resolve issues that arise when performing a cloud migration.

Cloud migration of applications also takes significant manual labor as applications must be painstakingly migrated per dependency. If any dependency is broken, the application may fail to function. Thus, there is a need to efficiently migrate applications while maintaining functionality. There is also a need to be able to perform the cloud migration quickly.

### SUMMARY

In some embodiments, the techniques described herein relate to a method including: receiving, at a query management platform, a query, wherein the query includes an application identifier; retrieving, by the query management platform and from a context data store, context data, wherein the context data is related to the application identifier; providing, by the query management platform, the query and the context data to a machine learning model as input to the machine learning model; receiving, at the query management platform and from the machine learning model, a request to search a private vector database associated with the query management platform; receiving, at the query management platform and from the machine learning model, a response to the query, wherein the response to the query is based on vector embeddings stored in the private vector database; and displaying, by the query management platform, the response to the query in a prompt.

In some embodiments, the techniques described herein relate to a method including: receiving, at a query management platform and from a client device, a query, wherein the query includes an application identifier of an application to be migrated from the client device to a cloud based platform; retrieving, by the query management platform and from a context data store, context data, wherein the context data is related to the application identifier; generating, by the query management platform, a prompt including the query and a migration profile including the context data as an embedding and provide the prompt to the machine learning model; receiving, at the query management platform and from the machine learning model, a request to search a private vector database for a stored term similar to a query term and providing the stored term and a vector to the machine learning model; receiving, at the query management platform and from the machine learning model, an executable script in response to the migration profile, the stored term, and the vector; and executing, by the query management platform on the client device, the executable script to migrate the application from the client device to the cloud based platform.

In some embodiments, the context data may include a public cloud capability and one or more constraints. In some embodiments, the request from the machine learning model may be received as a call to an application programming interface (API) of the query management platform. In some embodiments, the migration profile may further include application information retrieved by the query management platform from the application through a call through an application programming interface (API). In some embodiments, the method may further include displaying, through a connection to a user interface of the client device, a migration architecture. In some embodiments, the query management platform may embed the vector in the prompt. In some embodiments, the migration profile may include a key-value pair that represents an application information retrieved from the application and a selected value.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a block diagram of a system for providing model-generated content based on private data, in accordance with embodiments.

FIG. 2 illustrates a logical flow for providing model-generated content based on private data, in accordance with embodiments.

FIG. 3 illustrates a block diagram of a technology infrastructure and computing device for implementing certain embodiments of the present disclosure, in accordance with embodiments.

### DETAILED DESCRIPTION

Embodiments generally relate to systems and methods for providing model-generated content based on private data.

Embodiments may include an application migration program. The application migration program may be configured to migrate applications to a public cloud from a local network, computer system, or organization network. The benefits of migrating applications to the public cloud may include cost savings, scalability, flexibility, wider accessibility, and availability. Migrating applications to the public cloud may further be accomplished without a need for physical infrastructure. There are further advantages including increased security and an ability to update applications quickly and efficiently.

Embodiments allow migration to the cloud by determining, by the application migration program, application information, a public cloud capability, and one or more constraints. The public cloud capability may be a service provided by a public cloud provider. The service may be a database storage, object storage, a queue service, and messaging (e.g., first come first serve messaging or first in, first out messaging). The one or more constraints may be, for example, whether to read and write at the same time, at least two instances across two zones, a document database cannot be used or must be used, a critical application running across at least two availability zones (i.e., physical data centers), or an encryption of data transfer. Embodiments may include the application migration program building a prompt based on the application information, the public cloud capability and one or more constraints. The prompt may be used for a machine learning engine configured to resolve issues that arise when performing a cloud migration.

Further, because the migration profile is built from detected information, dependencies and functionality of the application are maintained during migration. Further, the migration process may be performed quickly and efficiently through disclosed embodiments. In some embodiments, the migration application may use refactoring during migration. Refactoring may include implementing significant changes to application configurations or code to enhance performance or behavior while maintaining the application's functionality. Further, the application's functionality is enhanced through support by multiple data centers that can be in different geographical areas that are unlikely or impossible to be affected by a disaster at the same time.

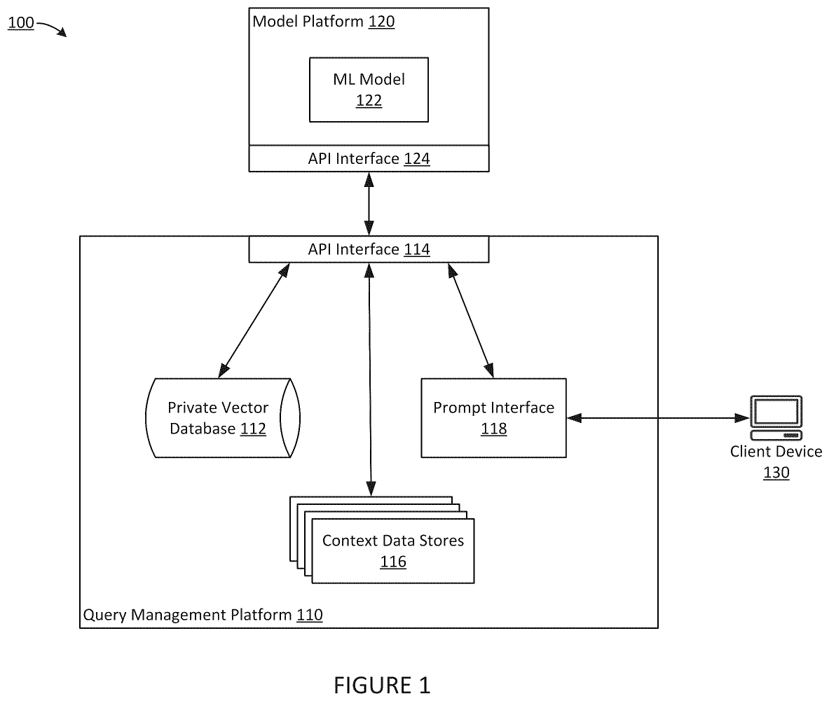

FIG. 1 illustrates a block diagram of a system for providing model-generated content based on private data, in accordance with embodiments.

System 100 includes query management platform 110, model platform 120, and client device 130. Query management platform 110 may be a local network, a cloud-based system, or a single computer. Query management platform 110 may include a processor and a memory including instructions that may cause the processor to perform application migration.

Query management platform 110 may include private vector database 112, API interface 114, context data stores 116, and prompt interface 118. Query management platform 110 may be operably connected to client device 130 to migrate an application from client device 130 to a cloud-based system. Client device 130 may include a local network or a computer. In some embodiments, query management platform 110 and client device 130 may both be included in an implementing organization's technology infrastructure.

Model platform 120 may include ML model 122 and API interface 124.

In accordance with embodiments, prompt interface 118 may be displayed on client device 130 via a local application executing on client device 130 such as a mobile application, a browser, etc. Prompt interface 118 may be configured to receive a query (e.g., a natural language query) from a user of client device 130.

Query management platform 110 may generate a prompt based on context data stores 116, application 140, a private vector database 112, and prompt interface 118.

As discussed above, query management platform 110 may receive a user query at prompt interface 118 and may retrieve an application ID from the user query. The application ID may be associated with application 140 to be migrated. The application 140 may be migrated from the client device or another network computer system to a cloud-based system. Query management platform 110 may use the application ID to retrieve context data from context data stores 116.

The context data may include a public cloud capability, and one or more constraints. The public cloud capability may be a service provided by a public cloud provider. The service may be a database storage, object storage, a queue service, and messaging (e.g., first come first serve messaging or first in, first out messaging). The one or more constraints may be, for example, whether to read and write at the same time, at least two instances across two zones, a document database cannot be used or must be used, a critical application running across at least two availability zones (i.e., physical data centers), or an encryption of data transfer. As discussed above, applications can be improved when migrating due to better security, multiple data centers, and reducing or eliminating errors upon migration to the cloud.

The application information may include internal application programming interface (API) data accessible through API interface 144 of application 140. The API data of the application 140 may be accessible by API interface 114 of query management platform 110. API data may be used as context information. The API data may include information about a network infrastructure. The information may include a type of run-time compute information including one or more of a cloud boundary of the application, whether an application is critical, a type of API used by the application, a type of OS used by the application, whether an admission privilege is required for access to a data container, whether graphic processing unit (GPU) acceleration is required, a type of a relational database, key-value, document, or graph used by the application, if a specific instance family is required, a number of protocols, a number of ports, a type of storage used, if a certain memory or number of central processing units (CPUs) are required, or whether a data of the application can be containerized. The information may further include whether there is a dependency to an on-prem representational state transfer (REST) API, if a virtual server infrastructure (VSI) is used by the application, if the application is using multiple regions, if an application integration uses messaging, streaming, or file processing, if the application consumption mode is pull or push, or if data transformation is required for the application integration. Further, the information may include whether the application includes a dependency on external connectivity, if there is an application requirement on content-based routing and filtering, if cross account application integration is required, if searching requires long-term archival, if searching an application requires integration with machine learning algorithms, if searching requires a service level agreement, if searching requires full text search for logs, or the type of platform of the source platform (e.g., VSI). For example, the API data may be whether an application is executed by a processor connected to and/or has data stored in one or two physical data centers.

Embodiments may include the query management platform 110 generating a migration profile from the application information and stored context data. The migration profile may allow quick and efficient migration of the application(s). The migration profile may be based on application information (e.g., decision factors) discussed above. The migration profile may include a set of key-value pairs that represent the application information and a selected value (e.g., yes, no, a number of CPUs, etc.). The prompt may include an embedded migration profile. Gathering the migration profile from an application avoids errors or lapses in functionality during migration of the application to the cloud.

The query management platform 110 may generate a diagram of the architecture based on the migration profile. The diagram may include a representation of a number of regions, a representation of a relational database, a connection to an on-premises database, and/or an object database.

Upon receiving the prompt through prompt interface 118, query management platform 110 may call an API method published by API interface 124 and pass the context data and the user query to ML model 122 as input to ML model 122. The prompt may be generated based on the application information, public cloud capability, and the one or more constraints. The application information may be retrieved from application 140. The public cloud capability may be based on the cloud that application 140 is to be migrated to. Application 140 may be part of an organization network, installed on client device 130, or installed on multiple computer systems. The prompt may be one or more written instructions based on the prompt and a context based on the application information, public cloud capability, and the one or more constraints. The prompt may be generated to allow an application migration program to quickly and efficiently migrate an application to a public cloud while maintaining the application's functionalities, dependencies, and deployments.

In some embodiments, ML model 122 may be configured to access private vector database 112, e.g., via API interface 114, and search private vector database 112 while generating a response to the received query. A response to the user query generated by ML model 122 may be provided to prompt interface 118 for display to a user on client device 130. The response may be an executable script capable of performing migration of application 140.

Embodiments may include query management platform 110 packaging individual services as images and deploying them to a serverless container hosting service in the public cloud.

Embodiments may include query management platform 110 load balancing to evenly distribute traffic and enable autoscaling.

Embodiments may include query management platform 110 including a multi-tier architecture to achieve independent scalability and to enhance database security. The multi-tier architecture may include a frontend, a backend, and a database. The multi-tier architecture may include a run-time compute system. Embodiments may include query management platform 110 configured to cache migration profiles or prompts in context data store 116. In some embodiments, the caching may be performed at a user request level.

Outputs of query management platform 110 may be an executable script capable of performing migration of application 140. The output may be in the form of a byte document. Outputs of the application migration program may be stored in a serverless document or database. The serverless document or database may be used to improve responses by the ML model 122 by training the machine learning program based on which results are successful and/or which are unsuccessful.

Embodiments may include query management platform 110 configured to provide outputs to client device 130 of each intermediary step of a solution to reduce or eliminate inaccurate or irrelevant responses from the machine learning engine.

Embodiments may include query management platform 110 that connected to ML model 122 so it provides access to ML model 122 to contextual data about an organization's technology infrastructure and applications for forming prompts. Embodiments may further include query management platform 110 accessing vector embeddings from private vector database 112 based on the organization's technical literature that the model may search and generate the prompt from. In some embodiments, query management platform 110 may access other data sources (e.g., data sources such as public databases or databases compiled from publicly available data) to generate the prompt. For example, query management platform 110 may be configured to connect to an internet to search a public database for information related to an unknown term from the application information.

Embodiments may include query management platform 110 configured to provide access to a query prompt (referred to as a “prompt” herein) of ML model 122 where users may provide a query that may be sent to the machine learning model. A prompt may also receive responses from a ML model or a model platform that hosts a ML model. Embodiments may also provide one or more context data stores. A query management platform may include logic and interfaces that can access a context data store and retrieve information therefrom. Embodiments may additionally include a private vector database that has been generated from artifacts provided by an implementing organization. A query management platform may provide access to a private vector database by a ML model or a platform that hosts a ML model. An ML model may access a private vector database and may search the private vector database when formulating responses to a query provided at a prompt.

In accordance with embodiments, query management platform 110 configured to generate a prompt based on a user query received through a user interface accessible through client device 130. The prompt may take a user query and may provide the query to ML model 122 (e.g., as a parameter or argument of an application programming interface (API) method exposed by the ML model or a platform that is hosting the model). An exemplary ML model 122 may be, e.g., a large language model (LLM) such as a Generative Pre-trained Transformer (GPT) model. As used herein a model platform is a platform that hosts a ML model and provides access to the ML model 122. Access to the ML model 122 may include an API interface 124 and/or an interface that includes input of a prompt.

A model platform may be a private platform that is provided by an implementing organization or may be a commercial platform that is accessible to an implementing organization. A model platform may provide access to a model, such as a LLM. A prompt may be configured to receive a user query in a natural language form and pass the query to the model hosted by the model platform. The prompt may be further configured to receive (e.g., as a return payload or otherwise in response to a called API method) a response to a user's query. The prompt may be configured to receive a query and provide a response in a conversational flow. For instance, a user's natural language query may be typed by the user into the prompt, and the prompt may display a natural language response to the query. A query/response “conversation” may be displayed by the prompt in a “thread” style, where each query is displayed in, e.g., a top-down flow so that a user may see each user query in a context of the user's other queries and a model's responses.

In accordance with embodiments, query management platform 110 may be configured to receive an application identifier (application ID), such as an alpha numeric string identifier as input to a prompt. In some embodiments, if an application identifier is not provided by a user, query management platform 110 may be configured to recognize the absence of an application identifier in a user's query (e.g., using regular expressions) and request that the user provide an application identifier. In exemplary embodiments, query management platform 110 may be configured to use an application ID as a lookup parameter in a query of one or more context data stores 116.

Context data store(s) 116 may store contextual information about an application of an implementing organization. Contextual information that may be associated with an application ID may include data such as where an application is currently provisioned (e.g., which infrastructure is used by the application), a required or suggested runtime compute environment (e.g., what type of run time and/or what type of library will be used), a required or suggested database environment (e.g., which relational database is used), or required dependencies. The required or suggested database environment may be where the application or the application data will be stored once migrated.

Upon receiving a query, query management platform 110 may retrieve an application ID and may query one or more context data stores 116 using the application ID to retrieve contextual data (e.g., application information) that is related to an application that is associated with the application ID. Contextual data that is related to an application may be stored with an association or relationship with the application's application ID. For example, an application may be configured as a primary key in a relational database that stores contextual data related to an implementing organization's applications. Context data store(s) 116 may be any necessary or desirable data store (e.g., a relational database, a data lake, a flat file, a data warehouse, etc.). Query management platform 110 may use an application ID as a lookup key in a query of a context data store and the query may return contextual data. Query management platform 110 may provide the contextual data along with an application ID and some or all of a user's query as input to ML model 122 of model platform 120.

In accordance with embodiments, query management platform 110 may host or be configured to access private vector database 112. Private vector database 112 may be a database that stores vector embeddings generated by an implementing organization. Vector embedding may be generated from natural language content (e.g., unstructured data such as natural language documents or webpages) that is owned, stored, accessed and/or accessed by an organization. For instance, technical literature related to or about an application, and/or an application's deployment, configuration, or dependencies, may be encoded into vector embeddings and stored in private vector database 112. Other technical literature may include documentation with respect to an organization's network infrastructure or preferred platforms.

In accordance with embodiments, query management platform 110 may provide a model platform with access to a private vector database. For instance, a query platform may provide an API interface that publishes API methods that allow for access to, and searching of, private vector database 112 for the purpose of using data in private vector database 112 to formulate responses to a query received at a prompt. Additionally, a model platform may be configured to access and search private vector database 112, exclusively or in addition to other data sources (e.g., data sources such as public databases or databases compiled from publicly available data), in order to generate a response to a query.

In an exemplary aspect, a query management system may receive, at a prompt, a user query where the query requests a migration plan for an application of an implementing organization to a cloud environment. Query management platform 110 may receive at a prompt, a user query including an application ID. The query management platform may retrieve the application ID and use the application ID in a query of a context data store to retrieve contextual data such as the applications profile, infrastructure dependencies, system dependencies, a preferred or required runtime compute environment, or a database engine/environment. Query management platform 110 may provide the contextual information to a model, such as a LLM, through the prompt or directly through an API method call as input to the model. The user's original query may also be provided via the prompt to the model as input to the model.

Query management platform 110 may be configured to search private vector database 112 that includes vector embeddings generated from the implementing organization's technical literature. Private vector database 112 allows use of different words with similar meanings and, when embedded in a machine learning engine, the result may be similar because the machine learning program determines the meaning to be the same. Private vector database 112 may be referenced by the query management platform 110 to determine a similarity between terms of the user request and stored terms. The similarity may be represented by a vector. The vector may be passed to the ML model 122 as part of the prompt.

The model may format a response that includes application migration plan details based on data in private vector database 112. Migration plan details may include, e.g., migration decision factors, a recommended migration architecture (e.g., a structure or a code representing a structure), an architecture diagram, and source code templates. The recommended migration architecture may include a number of regions that may be used. A response may be provided to a user via a prompt, a display, and/or in other suitable ways (e.g., a file download).

In another exemplary aspect, query management platform 110 may receive, at prompt interface 118, a user query where the query requests troubleshooting plan for an application of an implementing organization. The query may include a symptom of a problem experienced by the relevant application that the user wishes to troubleshoot. As discussed above, query management platform 110 may receive the user query from client device 130 and/or contextual information to be input to ML model 122. Based on the application ID and the symptom from the user's query, query management platform 110 may search the provided vector database and may return a number of relevant responses to the user. The prompt may be formed from the user query consistent with embodiments discussed above. For instance, a model platform and/or a query platform may be configured to display, e.g., a top 5 relevant responses with respect to troubleshooting an input symptom of an application.

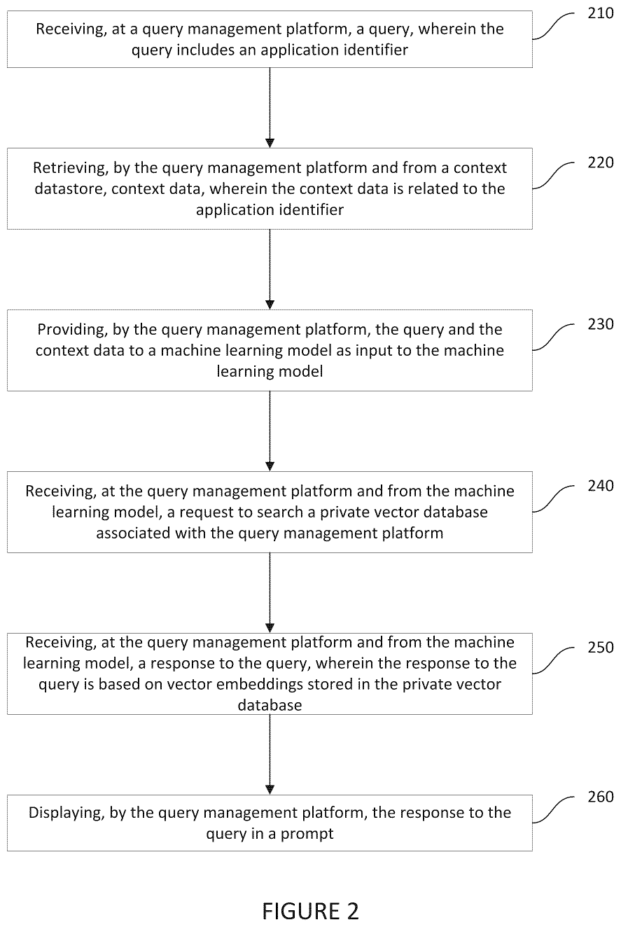

FIG. 2 is a logical flow for providing model-generated content based on private data, in accordance with embodiments.

Step 210 includes receiving, at a query management platform, a query, wherein the query includes an application identifier. The query may be received through a user interface available through a client device. The query may identify a storage location of the application to be migrated. The application may be stored at least partly of an on-premises memory. The application may be stored as part of a network organization or a single computer. The query management platform may access the application to determine application information. The query management platform may send a call through an API interface to gather information about the application. The application information may be similar to the application information discussed above.

Step 220 includes retrieving, by the query management platform and from a context data store, context data, wherein the context data is related to the application identifier. The context data may include data such as where an application is currently provisioned (e.g., which infrastructure is used by the application), a required or suggested runtime compute environment (e.g., what type of run time and/or what type of library will be used by the application), a required or suggested database environment (e.g., which relational database is used), or required dependencies. The context data may include one or more constraints consistent with disclosed embodiments. The context data may include a public cloud capability. The query management platform may generate a migration profile based on the query, the application information, and the context data. The migration profile may be embedded in the prompt.

Step 230 includes providing, by the query management platform, the migration profile to a machine learning model as input to the machine learning model. The machine learning model (ML model) may be similar to ML model 122 discussed above.

Step 240 includes receiving, at the query management platform and from the machine learning model, a request to search a private vector database (e.g., private vector database 112) associated with the query management platform. The request may be received as a call through an API interface (e.g., API interface 114) of the query management platform. The request to search the private vector database may be to determine a similarity between the user request and a known term. The similarity may be represented as a vector. The vector may be returned to the ML model to be used to produce a script to migrate the application.

Step 250 includes receiving, at the query management platform and from the ML model, a response to the prompt, wherein the response to the prompt is based on one or more vectors from the private vector database, the migration profile, and the user query. The response may be an executable script that, when executed by a processor, causes the processor to migrate the application from a local network or a computer to a cloud based system while maintaining the application's functionality and security.

Step 260 includes displaying, by the query management platform, a migration solution based on the prompt including one or more intermediate steps in response to the prompt. The display may include an executable script. The display may include the user interface displaying output details of the migration solution. The output details may include a time for migration based on an amount of data to be transferred and bandwidth, information from the migration profile, a security measure of a secure database to be transferred as part of the application migration, a migration of any dependencies, a number of regions of the application migration, one or more databases or object databases to be used after the application migration.

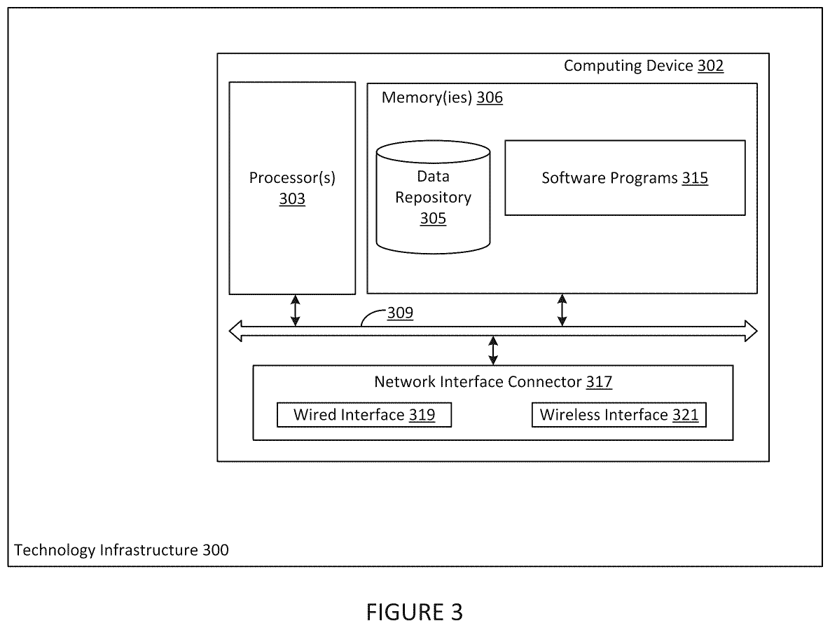

FIG. 3 is a block diagram of a technology infrastructure and computing device for implementing certain embodiments of the present disclosure, in accordance with embodiments. FIG. 3 includes technology infrastructure 300. Technology infrastructure 300 represents the technology infrastructure of an implementing organization. Technology infrastructure 300 may include hardware such as servers, client devices, and other computers or processing devices. Technology infrastructure 300 may include software (e.g., computer) applications that execute on computers and other processing devices. Technology infrastructure 300 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 300 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 300 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 300 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 300 may include both wired and wireless components and interfaces and may interface with servers and other hardware via either wired or wireless communications. A computer network of technology infrastructure 300 may be a private network but may interface with a public network (such as the internet) to facilitate operative communication between computers executing on technology infrastructure 300 and computers executing outside of technology infrastructure 300.

FIG. 3 further depicts exemplary computing device 302. Computing device 302 depicts exemplary hardware that executes the logic that drives the various system components described herein. Servers and client devices may take the form of computing device 302. While shown as internal to technology infrastructure 300, computing device 302 may be external to technology infrastructure 300 and may be in operative communication with a computing device internal to technology infrastructure 300.

In accordance with embodiments, system components such as a machine learning model, an API interface, a prompt interface, client devices, servers, various database engines and database services, and other computer applications and logic may include, and/or execute on, components and configurations the same, or similar to, computing device 302.

Computing device 302 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 302 may also have user interface components, such as a screen for displaying graphical user interfaces and receiving input from the user, a mouse, a keyboard and/or other input/output components (not shown).

In accordance with embodiments, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API interfaces. A published API method may be called by an application that is authorized to access the published API method. API methods may take data as one or more parameters or arguments of the called method. In some embodiments, API access may be governed by an API interface associated with a corresponding API. In some embodiments, incoming API method calls may be routed to an API interface and the API interface may forward the method calls to internal services/modules/engines that publish the API and its associated methods.

A service/module/engine that publishes an API may execute a called API method, perform processing on any data received as parameters of the called method, and send a return communication to the method caller (e.g., via an API interface). A return communication may also include data based on the called method, the method's data parameters and any performed processing associated with the called method.

API interfaces may be public or private interfaces. A public API interface may accept method calls from any source without first authenticating or validating the calling source. A private API interface may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some embodiments of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method comprising:
receiving, at a query management platform and from a client device, a query, wherein the query includes an application identifier of an application to be migrated from the client device to a cloud based platform;
retrieving, by the query management platform and from a context data store, context data, wherein the context data is related to the application identifier;
generating, by the query management platform, a prompt including the query and a migration profile including the context data as an embedding and provide the prompt to the machine learning model;
receiving, at the query management platform and from the machine learning model, a request to search a private vector database for a stored term similar to a query term and providing the stored term and a vector to the machine learning model;
receiving, at the query management platform and from the machine learning model, an executable script in response to the migration profile, the stored term, and the vector; and
executing, by the query management platform on the client device, the executable script to migrate the application from the client device to the cloud based platform.

2. The method of claim 1, wherein the context data includes a public cloud capability and one or more constraints.

3. The method of claim 1, wherein the request from the machine learning model is received as a call to an application programming interface (API) of the query management platform.

4. The method of claim 1, wherein the migration profile further includes application information retrieved by the query management platform from the application through a call through an application programming interface (API).

5. The method of claim 1, further including displaying, through a connection to a user interface of the client device, a migration architecture.

6. The method of claim 1, wherein the query management platform embeds the vector in the prompt.

7. The method of claim 1, wherein the migration profile includes a key-value pair that represents an application information retrieved from the application and a selected value.

8. A computer processing system comprising:
a memory configured to store instructions; and
a hardware processor operatively coupled to the memory for executing the instructions to:
receiving, at a query management platform and from a client device, a query, wherein the query includes an application identifier of an application to be migrated from the client device to a cloud based platform;
retrieve, by the query management platform and from a context data store, context data, wherein the context data is related to the application identifier;
generate, by the query management platform, a prompt including the query and a migration profile including the context data as an embedding and provide the prompt to the machine learning model;
receive, at the query management platform and from the machine learning model, a request to search a private vector database for a stored term similar to a query term and providing the stored term and a vector to the machine learning model;
receive, at the query management platform and from the machine learning model, an executable script in response to the migration profile, the stored term, and the vector; and
executing, by the query management platform on the client device, the executable script to migrate the application from the client device to the cloud based platform.

9. The system of claim 8, wherein the context data includes a public cloud capability and one or more constraints.

10. The system of claim 8, wherein the request from the machine learning model is received as a call to an application programming interface (API) of the query management platform.

11. The system of claim 8, wherein the migration profile further includes application information retrieved by the query management platform from the application through a call through an application programming interface (API).

12. The system of claim 8, further including displaying, through a connection to a user interface of the client device, a migration architecture.

13. The system of claim 8, wherein the query management platform embeds the vector in the prompt.

14. The system of claim 8, wherein the migration profile includes a key-value pair that represents an application information retrieved from the application and a selected value.

15. A non-transitory computer readable storage medium, including instructions stored thereon, which when read and executed by one or more computer processors, cause the one or more computer processors to perform steps comprising:
receiving, at a query management platform and from a client device, a query, wherein the query includes an application identifier of an application to be migrated from the client device to a cloud based platform;
retrieving, by the query management platform and from a context data store, context data, wherein the context data is related to the application identifier;
generating, by the query management platform, a prompt including the query and a migration profile including the context data as an embedding and provide the prompt to the machine learning model;
receiving, at the query management platform and from the machine learning model, a request to search a private vector database for a stored term similar to a query term and providing the stored term and a vector to the machine learning model;
receiving, at the query management platform and from the machine learning model, an executable script in response to the migration profile, the stored term, and the vector; and
executing, by the query management platform on the client device, the executable script to migrate the application from the client device to the cloud based platform.

16. The non-transitory computer readable storage medium of claim 15, wherein the context data includes a public cloud capability and one or more constraints.

17. The non-transitory computer readable storage medium of claim 15, wherein the request from the machine learning model is received as a call to an application programming interface (API) of the query management platform.

18. The non-transitory computer readable storage medium of claim 15, further including displaying, through a connection to a user interface of the client device, a migration architecture.

19. The non-transitory computer readable storage medium of claim 15, wherein the query management platform embeds the vector in the prompt.

20. The non-transitory computer readable storage medium of claim 15, wherein the migration profile includes a key-value pair that represents an application information retrieved from the application and a selected value.
